(19) United States
(12) Patent Application Publication
(10) Pub. No.: US 2020/0195077 A1
(43) Pub. Date: Jun. 18, 2020

(54) ELECTRICAL INSULATION TAPE, HIGH-VOLTAGE ELECTRICAL MACHINE, AND METHOD FOR PRODUCING AN ELECTRICAL INSULATION TAPE AND A HIGH-VOLTAGE ELECTRICAL MACHINE

(71) Applicant: Siemens Aktiengesellschaft, Munich (DE)

(72) Inventors: Andrey Mashkin, Koln (DE); Mario Brockschmidt, Essen (DE); Friedhelm Pohlmann, Essen (DE)

(73) Assignee: Siemens Aktiengesellschaft, Munich (DE)

(21) Appl. No.: 16/500,605

(22) PCT Filed: Jan. 9, 2018
(86) PCT No.: PCT/EP2018/050401

§ 371 Date: Oct. 3, 2019

(30) Foreign Application Priority Data
Apr. 4, 2017 (EP) 17164715.9

(51) Int. Cl. H02K 3/40; H01B 3/48; H01B 3/40; H01B 3/04; H02K 15/12; H02K 3/30

(52) U.S. Cl. CPC H02K 3/40; H01B 3/48; H02K 3/30; H01B 3/04; H02K 15/12; H01B 3/40

(57) ABSTRACT

An electrical insulation tape for a high-voltage electrical machine, having a particle composite that can be impregnated, which has a plurality of platelet-shaped electrical insulation particles, and having first spacing particles, which are applied to the surface of the electrical insulation tape such that the porosity of the electrical insulation tape is higher in the region of the first spacing particles than in the region of the particle composite that can be impregnated.

### CROSS REFERENCE TO RELATED APPLICATIONS

This application is the US National Stage of International Application No. PCT/EP2018/050401 filed 9 Jan. 2018, and claims the benefit thereof. The International Application claims the benefit of European Application No. EP17164715 filed 4 Apr. 2017. All of the applications are incorporated by reference herein in their entirety.

### FIELD OF INVENTION

The invention relates to a high-voltage electrical machine comprising an electrical insulation tape and to a method for producing the electrical insulation tape and to a method for producing the high-voltage electrical machine comprising the electrical insulation tape.

### BACKGROUND OF INVENTION

A high-voltage electrical machine, such as a generator and/or a motor, for example, comprises an electrical conductor, an electrical insulation system and a laminated stack. The purpose of the electrical insulation system is to electrically insulate the electrical conductors permanently from one another, from the laminated stack and from the environment. During operation of the electrical machine, partial electrical discharges occur, leading to the formation of so-called “treeing” channels in the electrical insulation system. In the region of the “treeing” channels, the electrical insulation system is electrically loadable only to a reduced extent and an electrical breakdown through the electrical insulation system can occur. A barrier against the partial discharges is achieved by an electrical insulation tape being provided in the electrical insulation system. The electrical insulation tape comprises a plurality of electrical insulation particles, such as mica, for example.

Producing the electrical insulation system involves firstly winding the electrical insulation tape around the electrical conductor and then impregnating it with an impregnating resin. For the purpose of impregnation, the electrical conductor with the electrical insulation tape wound around it is impregnated with the impregnating resin for example in a trough containing the impregnating resin. What is disadvantageous, however, is that defects can form in the electrical insulation system, said defects not being impregnated by the impregnating resin. In the region of said defects, partial discharges that can lead to the formation of the “treeing” channels can arise during operation of the high-voltage electrical machine. The defects are thus disadvantageous because they result in the lifetime of the high-voltage electrical machine being shortened.

### SUMMARY OF INVENTION

It is an object of the invention, therefore, to provide an electrical insulation tape for a high-voltage electrical machine, the high-voltage electrical machine comprising the electrical insulation tape, a method for producing the electrical insulation tape and for producing the high-voltage electrical machine, wherein the high-voltage electrical machine has a long lifetime.

In a first embodiment, the electrical insulation tape according to the invention for a high-voltage electrical machine comprises an impregnatable particle composite comprising a plurality of laminar electrical insulation particles, and first spacer particles applied to a surface of the electrical insulation tape, such that the porosity of the electrical insulation tape is higher in the region of the first spacer particles than in the region of the impregnatable particle composite. In this embodiment, none of the spacer particles is provided in the impregnatable particle composite.

In a second embodiment, the electrical insulation tape according to the invention for a high-voltage electrical machine comprises an impregnatable particle composite comprising a plurality of laminar electrical insulation particles and second spacer particles arranged in a manner distributed between the laminar electrical insulation particles, such that the porosity of the impregnatable particle composite is higher than in the corresponding impregnatable particle composite without the second spacer particles. In this embodiment, none of the spacer particles is provided on the surface of the electrical insulation tape.

In a third embodiment, the electrical insulation tape according to the invention for a high-voltage electrical machine comprises an impregnatable particle composite comprising a plurality of laminar electrical insulation particles, and first spacer particles applied to a surface of the electrical insulation tape, wherein the impregnatable particle composite comprises second spacer particles arranged in a manner distributed between the laminar electrical insulation particles, such that the porosity of the impregnatable particle composite is higher than in the corresponding impregnatable particle composite without the second spacer particles and the porosity of the electrical insulation tape is higher in the region of the first spacer particles than in the region of the corresponding impregnatable particle composite without the second spacer particles.

The electrical insulation tape according to the invention comprises the first spacer particles and/or the second spacer particles, which increase the porosity of the electrical insulation tape. By virtue of this increase in the porosity, by means of impregnating the electrical insulation tape with an impregnating resin it is possible to produce an electrical insulation system having no defects that are not impregnated by the impregnating resin. As a result, the high-voltage electrical machine tends toward the formation of partial discharges to a lesser extent, as a result of which the high-voltage electrical machine advantageously has a long lifetime. The inventors have surprisingly found that the time until complete impregnation of the electrical insulation tape with the impregnating resin can be shortened by virtue of the increased porosity. By virtue of the fact that the time until complete impregnation of the electrical insulation tape can be shortened, this results in a reduction of the personnel costs and the process costs.

Avoiding the defects has the consequence that interfaces between regions free of the impregnating resin and regions impregnated by the impregnating resin cannot form in the electrical insulation system. These interfaces are disadvantageous because cracks can form there or delamination can take place there. Avoiding formation of the cracks and delamination results in an increase in the lifetime of the high-voltage electrical machine.

The porosity here is the ratio of the volume of all pores in the electrical insulation tape to the total volume of the electrical insulation tape.

The laminar electrical insulation particles advantageously comprise mica and/or aluminum oxide. These substances advantageously have a high durability vis-à-vis partial discharges.

It is advantageous for the first spacer particles and/or the second spacer particles to comprise an epoxy, an elastomer, a thermoplastic and/or inorganic substances, in particular titanium oxide and/or aluminum oxide, wherein the spacer particles have in particular two volume regions comprising different chemical substances, wherein one volume region regionally or completely encloses the other volume region, which is substantially spherical, in particular. The spacer particles can be chosen such that the spacer particles at least partly are dissolved in the impregnating resin during impregnation and/or curing for example on account of a pressure and/or temperature present during the impregnation and/or during the curing and/or become deformed during the impregnation and/or the curing. As a result of the dissolution and/or deformation, no additional interfaces arise between the spacer particles and the impregnating resin. It is thus possible to counteract the formation of the cracks and the delamination in the electrical insulation system, as a result of which the lifetime thereof and thus the lifetime of the high-voltage electrical machine are lengthened. Furthermore, as a result of the dissolution and/or deformation of the spacer particles, the pores in the electrical insulation tape and/or in the electrical insulation system are reduced, and so the remaining constituents of the electrical insulation tape can relax. By way of example, the distances between the electrical insulation particles in the particle composite increase if they have dissolved, and the particle composite can then expand into this volume produced as a result of the dissolution of the spacer particles. This enables a better impregnation of the particle composite and at the same time a more uniform distribution of the electrical insulation particles in the electrical insulation system, with the result that no pronounced interfaces arise, which counteracts the formation of the cracks and the delamination.

In this case, one volume region can have the shape of a spherical surface at its outwardly facing surface. Furthermore, it is possible for the spacer particles, if they have the two volume regions comprising the different chemical substances, to comprise the inorganic substances at the inner area and the epoxies, the elastomers and/or the thermoplastics at the outer area. In this case, it is conceivable that only the epoxies, the elastomers and/or the thermoplastics are dissolved and/or become deformed during the impregnation and/or during the curing.

The spacer particles are advantageously present as an agglomerate. In this case, it is conceivable that the spacer particles are chosen such that the mechanisms for forming the agglomerates are deactivated during the impregnation and/or during the curing, with the result that the agglomerates break up into the individual spacer particles. In particular, in this case, if the spacer particles have the two volume regions comprising the different chemical substances, the impregnating resin can interact with the outer volume region of the spacer particles and thus cancel the mechanisms for forming the agglomerates.

The impregnating resin is advantageously selected from a group comprising polyester derivatives, in particular unsaturated polyester imides, bisphenol A diglycidyl ethers, bisphenol F diglycidyl ethers, phenolic novolacs, aliphatic epoxies and/or cycloaliphatic epoxies.

The first spacer particles and the second spacer particles are advantageously selected from a group comprising bisphenol A diglycidyl ethers, bisphenol F diglycidyl ethers, phenolic novolacs, aliphatic epoxies and/or cycloaliphatic epoxies. The elastomer advantageously comprises a styrene-butadiene rubber. The thermoplastic advantageously comprises an acrylonitrile-butadiene-styrene, a polyamide, a polylactate and/or a polymethyl methacrylate.

The first spacer particles and/or the second spacer particles have a coating, for example, in order to locally improve the flowability of the impregnating resin. The coating can be a silane group, for example. The silane group advantageously does not react with the impregnating resin. By virtue of the fact that the first spacer particles and/or the second spacer particles locally improve the flowability of the impregnating resin, the impregnation of the electrical insulation tape is advantageously shortened.

The first spacer particles and/or the second spacer particles are advantageously substantially spherical. The spherical shape is advantageous, particularly for the second spacer particles introduced into the particle composite, in order to obtain a high porosity in the electrical insulation tape even upon contact between the laminar electrical insulation particles and the second spacer particles.

The second spacer particles, in the case where they are substantially spherical, advantageously have a diameter that is longer than the average thickness of the laminar electrical insulation particles, since this results in the formation of the high porosity in the electrical insulation tape.

The first spacer particles and/or the second spacer particles have for example a size in the range of 10 nm to 80 μm, wherein the size is the longest extent in the spacer particles. In this case, the first spacer particles can have a different size distribution than the second spacer particles. In particular, the first spacer particles can have a larger mean particle size than the second spacer particles. The first spacer particles can be embodied as laminar particles, for example. As a result, the first spacer particles are particularly well suited to maintaining a spacing between directly adjacently arranged electrical insulation tapes or directly adjacently arranged sections of the same electrical insulation tape, in particular because a surface of the electrical insulation tape is often uneven.

In one embodiment, the impregnatable particle composite is applied to a carrier material comprising a knitted fabric, in particular a glass knitted fabric, a nonwoven, a foam, in particular an open-pored foam, a glass roving, a woven fabric and/or a resin mat comprising fibers comprising glass and/or plastic, in particular. As a result, the strength of the electrical insulation tape is increased and the processability thereof is simplified. The carrier material is advantageously porous in order that it is impregnatable by the impregnating resin. The carrier material is advantageously electrically nonconductive. The carrier material is adhesively bonded to the particle composite, for example.

The high-voltage electrical machine according to the invention comprises an electrical conductor, an electrical insulation tape wound around the electrical conductor, and an impregnating resin, wherein the electrical insulation tape is impregnated by the impregnating resin and the impregnating resin is cured.

The electrical insulation tape is advantageously wound around the electrical conductor in a manner partly overlapping itself.

In a first method according to the invention for producing an electrical insulation tape, the method comprises the following steps: a) producing an impregnatable particle composite comprising a plurality of laminar electrical insulation particles; b) producing the electrical insulation tape comprising the impregnatable particle composite and first spacer particles applied to a surface of the electrical insulation tape, in particular by a dispersion that comprises the first spacer particles and a fluid being sprayed onto the surface, such that the porosity of the electrical insulation tape is higher in the region of the first spacer particles than in the region of the impregnatable particle composite without the second spacer particles. In this method, none of the spacer particles is provided in the impregnatable particle composite.

In a second method according to the invention for producing an electrical insulation tape, the method comprises the following steps: a) producing an impregnatable particle composite comprising a plurality of laminar electrical insulation particles and second spacer particles arranged in a manner distributed between the laminar electrical insulation particles; b) producing the electrical insulation tape comprising the impregnatable particle composite, wherein the porosity of the impregnatable particle composite is higher than in the corresponding impregnatable particle composite without the second spacer particles. In this method, none of the spacer particles is provided on the surface of the electrical insulation tape.

In a third method according to the invention for producing an electrical insulation tape, the method comprises the following steps: a) producing an impregnatable particle composite comprising a plurality of laminar electrical insulation particles and second spacer particles arranged in a manner distributed between the laminar electrical insulation particles; b) producing the electrical insulation tape comprising the impregnatable particle composite and first spacer particles applied to a surface of the electrical insulation tape, in particular by a dispersion that comprises the first spacer particles and a fluid being sprayed onto the surface, such that the porosity of the impregnatable particle composite is higher than in the corresponding impregnatable particle composite without the second spacer particles and the porosity of the electrical insulation tape is higher in the region of the first spacer particles than in the region of the corresponding impregnatable particle composite without the second spacer particles.

The impregnatable particle composite can be produced for example by producing a dispersion of the laminar electrical insulation particles in a carrier fluid, such as water, for example. The dispersion is subsequently sedimented, thus giving rise to a sediment comprising the laminar electrical insulation particles. The carrier fluid is then removed from the sediment, as a result of which the sediment forms the particle composite. The first spacer particles, which are applied to the surface of the particle composite or to the surface of the electrical insulation tape in particular with a dispersion, can be sprayed on for example manually or by machine.

It is advantageous for the first spacer particles and/or the second spacer particles to be substantially spherical.

Advantageously, the method comprises the following step: a1) applying the impregnatable particle composite to a carrier material comprising a knitted fabric, in particular a glass knitted fabric, a nonwoven, a foam, in particular an open-pored foam, a glass roving, a woven fabric and/or a resin mat comprising fibers comprising glass and/or plastic, in particular.

According to the invention, the method for producing a high-voltage electrical machine comprises the following additional steps: c) providing an electrical insulation tape produced in accordance with methods above and an electrical conductor; d) winding the electrical insulation tape around the electrical conductor; e) impregnating the electrical insulation tape with an impregnating resin; and f) curing the impregnating resin.

Advantageously, in step e) and/or step f) the first spacer particles and/or the second spacer particles at least partly are dissolved in the impregnating resin and/or the first and/or the second spacer particles become deformed. This can be carried out for example in such a way that the melting point and/or compressive strength of the first spacer particles and/or of the second spacer particles are/is chosen so as to be lower than the temperature and/or pressure of the impregnating resin during the impregnation and/or during the curing. The melting point can be set for example by way of a choice of the chain length of the epoxies of the first spacer particles and/or of the second spacer particles.

It is advantageous for the first spacer particles and/or the second spacer particles to comprise an epoxy, an elastomer, a thermoplastic and/or inorganic substances, in particular titanium oxide and/or aluminum oxide, wherein the spacer particles have in particular two volume regions comprising different chemical substances, wherein one volume region regionally or completely encloses the other volume region, which is substantially spherical, in particular.

It is conceivable that the first spacer particles are applied on a first side and/or on a second side, which are part of the surface of the electrical insulation tape, of the electrical insulation tape. The properties with regard to impregnatability of the electrical insulation tape are considerably improved as a result. The terms “first side” and “second side” relate to the broad sides of the electrical insulation tape, that is to say to the two sides which face away from one another and whose extent in a cross section through the electrical insulation tape is longer by a multiple than the extent of the other two sides facing away from one another. The surfaces to which the first spacer particles are advantageously applied are those whose extent in cross section through the electrical insulation tape is longer by a multiple than the extent of the other two sides situated opposite one another. The first spacer particles can for example also be applied on two, three or four sides of the electrical insulation tape.

The impregnation of the electrical insulation tape with the impregnating resin and/or the curing of the impregnating resin are/is advantageously carried out by means of a vacuum pressure impregnation (VPI) process and/or a resin rich method. Both methods involve setting a temperature at which a curing agent reacts with the impregnating resin, with the result that the impregnating resin partly gels. The curing of the impregnating resin is carried out at a higher temperature than the impregnation in order to enable the polymerization of the impregnating resin, for example at approximately 150° C. or higher. The curing agent should advantageously be chosen depending on the impregnating resin used and particularly advantageously comprises dicyandiamide and/or 4,4′-diaminodiphenylsulfone.

### BRIEF DESCRIPTION OF THE DRAWINGS

Embodiments of a high-voltage electrical machine according to the invention comprising an electrical insulation tape according to the invention are presented below with reference to schematic drawings.

FIG. 1 shows a schematic illustration of the high-voltage electrical machine.

FIG. 2 shows a schematic illustration of two layers of the electrical insulation tape before impregnation with an impregnating resin.

FIG. 3 shows a schematic illustration of the two layers of the electrical insulation tape after or during the impregnation with the impregnating resin.

FIG. 4 shows a schematic detail view of a particle composite.

### DETAILED DESCRIPTION OF INVENTION

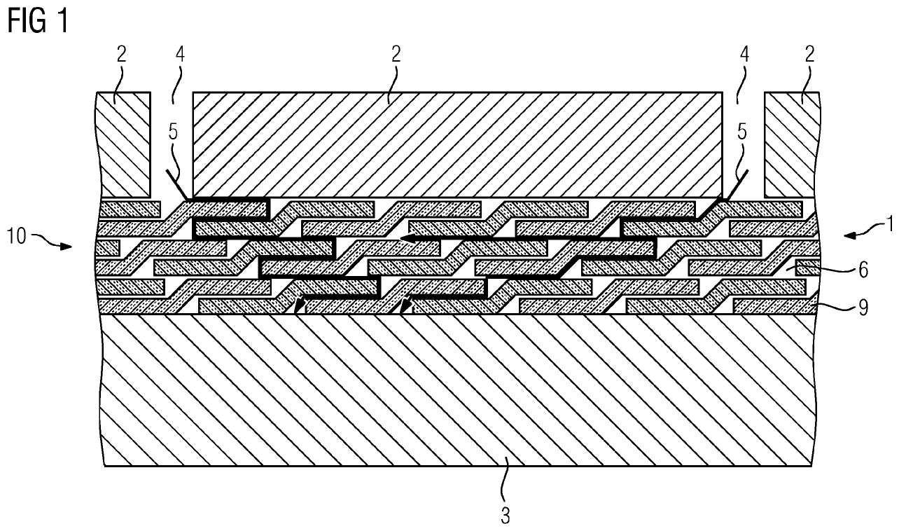

As is evident from FIGS. 1 to 4, a high-voltage electrical machine 10 comprises a laminated stack 2 and an electrical conductor 3. The high-voltage electrical machine 10 can be an electrical generator and/or an electric motor, for example. The laminated stack 2 has a plurality of cooling cutouts 4. The cooling cutouts 4 serve for as efficient cooling as possible by virtue of the fact that a cooling fluid can flow directly into the vicinity of the electrical conductor 3. In addition, an impregnating resin is introduced into the electrical insulation tape 9 via the cooling cutouts 4. For the purpose of electrically insulating the electrical conductor 3, the high-voltage electrical machine 10 comprises an electrical insulation tape 9, which is wound around the electrical conductor 3. The electrical conductor 3 with the electrical insulation tape 9 wound around it is arranged in a slot in the laminated stack 2 in the high-voltage electrical machine 10. As is evident in FIG. 1, the high-voltage electrical machine 10 comprises a plurality of layers of an electrical insulation tape 9 wound around the electrical conductor 3 in such a way that a first turn of the electrical insulation tape 9 together with a second turn of the electrical insulation tape 9, said second turn being adjacent to the first turn, partly overlaps itself. By virtue of this overlapping turn, a first section of the first turn is situated in one plane at a first radial distance from the electrical conductor 3 and a second section of the first turn is situated in another plane at a second radial distance, which is different than the first radial distance, from the electrical conductor 3. Winding cavities 6 form in that transition region between one plane and the other plane. The winding cavities 6 are advantageous for a good impregnation of the electrical insulation tape 9 because here the impregnating resin is able to flow easily. Once the different layers of the electrical insulation tape 9 are impregnated with the impregnating resin and cured, an electrical insulation system 1 comprising the electrical insulation tape 9 and the impregnating resin is formed. The impregnation of the different layers of the electrical insulation tape 9 takes place for example along the impregnating resin penetration paths 5 depicted in FIG. 1, which also lead through the winding cavities 6, in particular.

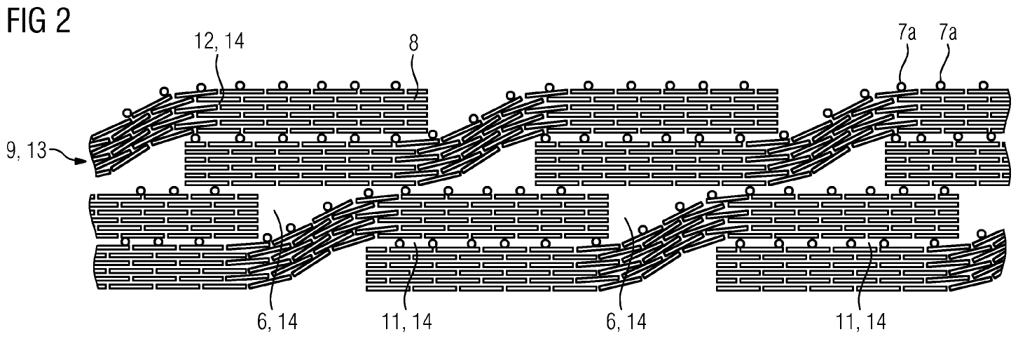

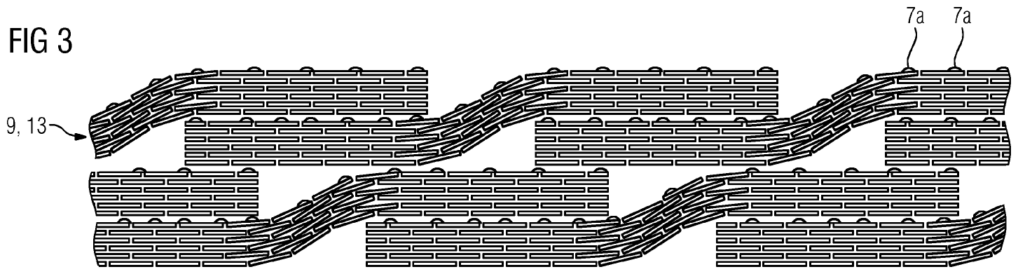

FIGS. 2 and 3 show a first embodiment of the electrical insulation tape 9. The electrical insulation tape 9 comprises an impregnatable particle composite 13a comprising a plurality of laminar electrical insulation particles 8, and first spacer particles 7a. The laminar electrical insulation particles 8 ensure that an undesired partial discharge between the laminated stack 2 and the electrical conductor 3 is avoided. For this purpose, the laminar electrical insulation particles 8 can comprise mica and/or aluminum oxide; in particular, the laminar electrical insulation particles 8 can consist of mica or aluminum oxide. In FIG. 2, a plurality of first spacer particles 7a are arranged adjacently on a first side of the electrical insulation tape 9, said first side being at a greater radial distance from the electrical conductor 3 in comparison with a second side of the electrical insulation tape 9. The first spacer particles 7a can for example also be applied on the second side of the electrical insulation tape 9 and/or on all four sides of the electrical insulation tape 9. The first spacer particles 7a provide for an increased porosity in the electrical insulation tape 9 in comparison with an electrical insulation tape 9 without the first spacer particles 7a. By virtue of the fact that the first spacer particles 7a lengthen the radial distance in the region in which the adjacent turns of the electrical insulation tape 9 overlap, the winding cavities 6 are also enlarged, which further increases the impregnatability of the wound electrical insulation tape 9. FIG. 2 shows the electrical insulation tape 9 before the impregnation with the impregnating resin.

FIG. 3 shows the first embodiment after or during the impregnation with the impregnating resin or after or during the curing of the impregnating resin. The difference with respect to FIG. 2 is that the first spacer particles 7a are no longer spherical, but rather have at least partly dissolved in the impregnating resin. The first spacer particles 7a can at least partly dissolve in the impregnating resin. Schematic FIG. 3 illustrates the first spacer particles 7a in a transition state. This transition state shows the first spacer particles 7a as neither spherical nor completely dissolved in the impregnating resin, but rather in an intermediate stage. In this stage, the interparticulate distances increase, which further increases the impregnatability of the wound electrical insulation tape 9. On account of the improved impregnatability, the electrical insulation system 1 is more elastic after curing. FIG. 3 thus advantageously relates to a point in time during the impregnation process or the curing process rather than to a point in time after curing. Dissolving the first spacer particles 7a can be effected for example such that the melting point of the first spacer particles 7a is chosen so as to be lower than the temperature of the impregnating resin during the impregnation and/or during the curing. The melting point can be set for example by way of a choice of the chain length of the epoxies of the first spacer particles 7a.

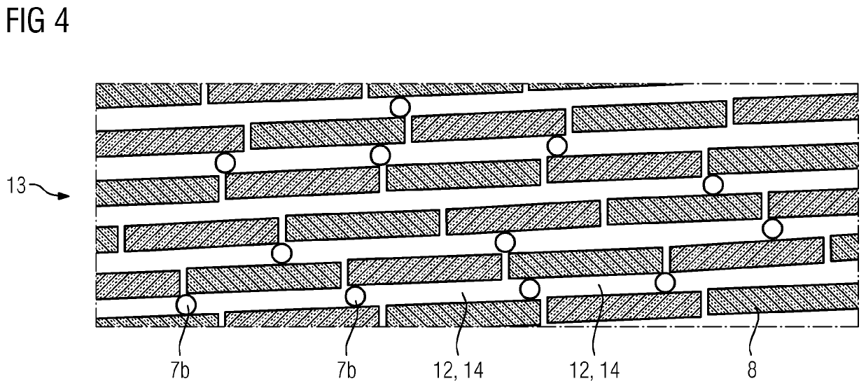

FIG. 4 shows a detail view of a second embodiment of the electrical insulation tape 9. The electrical insulation tape 9 comprises an impregnatable particle composite 13b comprising a plurality of laminar electrical insulation particles 8. The laminar electrical insulation particles 8 can comprise mica and/or aluminum oxide; in particular, the laminar electrical insulation particles 8 can consist of mica or aluminum oxide. In this case, the particle composite 13b comprises a plurality of layers of adjacently arranged laminar electrical insulation particles 8. On account of their laminar shape, the adjacently arranged laminar electrical insulation particles 8 have two large surfaces facing away from one another, and a plurality of small surfaces. In the impregnatable particle composite 13, the laminar electrical insulation particles 8 of a layer are arranged in such a way that one of the laminar electrical insulation particles 8 faces another of the laminar electrical insulation particles 8 with one of the small surfaces. A plurality of second spacer particles 7b are arranged in a manner distributed between the laminar electrical insulation particles 8. In this case, the second spacer particles 7b can be arranged between different layers of the laminar electrical insulation particles 8 and/or between different laminar electrical insulation particles 8 of a layer. By virtue of the fact that the second spacer particles 7b are arranged between the laminar electrical insulation particles 8, this results in an increase in the porosity of the electrical insulation tape 9 in the impregnatable particle composite 13. This in turn results in an improved impregnatability of the closely adjacent laminar electrical insulation particles 8 and thus in a better impregnatability of the impregnatable particle composite 13b and of the entire electrical insulation tape 9. The second spacer particles 7b can comprise for example an epoxy, an elastomer, a thermoplastic and/or inorganic substances, in particular titanium oxide and/or aluminum oxide, wherein the spacer particles 7a, 7b have two volume regions comprising different chemical substances, wherein one volume region regionally or completely encloses the other volume region, which is substantially spherical, in particular. The spherical shape is advantageous particularly for the second spacer particles 7b introduced into the impregnatable particle composite 13b, in order to obtain a high porosity in the electrical insulation tape 9 even upon contact between the laminar electrical insulation particles 8 and the second spacer particles 7b. The second spacer particles 7b, in the case where they are substantially spherical, advantageously have a diameter that is between 10 nm and substantially the average thickness of the laminar electrical insulation particles 8, since this results in the formation of a high porosity in the electrical insulation tape 9.

Although the invention has been more specifically illustrated and described in detail by means of exemplary embodiments, nevertheless the invention is not restricted by the examples disclosed and other variations can be derived therefrom by the person skilled in the art, without departing from the scope of protection of the invention.

1. An electrical insulation tape for a high-voltage electrical machine, comprising:
an impregnatable particle composite comprising a plurality of laminar electrical insulation particles, and first spacer particles applied to a surface of the electrical insulation tape, such that the porosity of the electrical insulation tape is higher in the region of the first spacer particles than in the region of the impregnatable particle composite.

2. An electrical insulation tape for a high-voltage electrical machine, comprising:
an impregnatable particle composite comprising a plurality of laminar electrical insulation particles and second spacer particles arranged in a manner distributed between the laminar electrical insulation particles, such that the porosity of the impregnatable particle composite is higher than in the corresponding impregnatable particle composite without the second spacer particles.

3. An electrical insulation tape for a high-voltage electrical machine, comprising:
an impregnatable particle composite comprising a plurality of laminar electrical insulation particles, and first spacer particles applied to a surface of the electrical insulation tape,
wherein the impregnatable particle composite comprises second spacer particles arranged in a manner distributed between the laminar electrical insulation particles, such that the porosity of the impregnatable particle composite is higher than in the corresponding impregnatable particle composite without the second spacer particles and the porosity of the electrical insulation tape is higher in the region of the first spacer particles than in the region of the corresponding impregnatable particle composite without the second spacer particles.

4. The electrical insulation tape as claimed in claim 3,
wherein the first spacer particles and/or the second spacer particles comprise an epoxy, an elastomer, a thermoplastic and/or inorganic substances, titanium oxide and/or aluminum oxide; and/or
wherein the spacer particles have two volume regions comprising different chemical substances, wherein one volume region regionally or completely encloses the other volume region, which is substantially spherical.

5. The electrical insulation tape as claimed claim 3,
wherein the first spacer particles and/or the second spacer particles are substantially spherical.

6. The electrical insulation tape as claimed in claim 3,
wherein the impregnatable particle composite is applied to a carrier material comprising a knitted fabric, a glass knitted fabric, a nonwoven, a foam, an open-pored foam, a glass roving, a woven fabric, a resin mat, and/or a resin mat comprising fibers comprising glass and/or plastic.

7. A high-voltage electrical machine, comprising:
the electrical insulation tape as claimed in claim 3,
an electrical conductor, the electrical insulation tape wound around the electrical conductor, and an impregnating resin,
wherein the electrical insulation tape is impregnated by the impregnating resin and the impregnating resin is cured.

8. The high-voltage electrical machine as claimed in claim 7,
wherein the electrical insulation tape is wound around the electrical conductor in a manner partly overlapping itself.

9. A method for producing an electrical insulation tape comprising:
a) producing an impregnatable particle composite comprising a plurality of laminar electrical insulation particles;
b) producing the electrical insulation tape comprising the impregnatable particle composite and first spacer particles applied to a surface of the electrical insulation tape, such that the porosity of the electrical insulation tape is higher in the region of the first spacer particles than in the region of the impregnatable particle composite.

10. A method for producing an electrical insulation tape comprising:
a) producing an impregnatable particle composite comprising a plurality of laminar electrical insulation particles and second spacer particles arranged in a manner distributed between the laminar electrical insulation particles;
b) producing the electrical insulation tape comprising the impregnatable particle composite, wherein the porosity of the impregnatable particle composite is higher than in the corresponding impregnatable particle composite without the second spacer particles.

11. A method for producing an electrical insulation tape comprising:
a) producing an impregnatable particle composite 4 comprising a plurality of laminar electrical insulation particles and second spacer particles arranged in a manner distributed between the laminar electrical insulation particles;
b) producing the electrical insulation tape comprising the impregnatable particle composite and first spacer particles applied to the surface of the electrical insulation tape, in particular by a dispersion that comprises the first spacer particles and a fluid being sprayed onto the surface, such that the porosity of the impregnatable particle composite is higher than in the corresponding impregnatable particle composite without the second spacer particles and the porosity of the electrical insulation tape is higher in the region of the first spacer particles than in the region of the corresponding impregnatable particle composite without the second spacer particles.

12. The method as claimed in claim 11,
wherein the first spacer particles and/or the second spacer particles are substantially spherical.

13. The method as claimed in claim 11,
wherein in a step a1) the impregnatable particle composite is applied to a carrier material comprising a knitted fabric, a glass knitted fabric, a nonwoven, a foam, an open-pored foam, a glass roving, a woven fabric, a resin mat, and/or a resin mat comprising fibers comprising glass and/or plastic.

14. A method for producing a high-voltage electrical machine comprising:
c) providing an electrical insulation tape produced as claimed in claim 11 and an electrical conductor;
d) winding the electrical insulation tape around the electrical conductor;
e) impregnating the electrical insulation tape with an impregnating resin; and
f) curing the impregnating resin.

15. The method as claimed in claim 14,
wherein in step e) and/or step f) the first spacer particles and/or the second spacer particles at least partly are dissolved in the impregnating resin and/or become deformed.

16. The method as claimed in claim 14,
wherein the first spacer particles and/or the second spacer particles comprise an epoxy, an elastomer, a thermoplastic and/or inorganic substances, titanium oxide and/or aluminum oxide; and/or
wherein the spacer particles have two volume regions comprising different chemical substances, wherein one volume region regionally or completely encloses the other volume region, which is substantially spherical.

17. The method as claimed in claim 14,
wherein the first spacer particles and/or the second spacer particles are present as an agglomerate, which are broken up into the individual first spacer particles and/or into the individual spacer particles in step e) and/or in step f).

18. The method for producing an electrical insulation tape of claim 9,
wherein producing the electrical insulation tape comprising the impregnatable particle composite and first spacer particles applied to a surface of the electrical insulation tape is done by a dispersion that comprises the first spacer particles and a fluid being sprayed onto the surface.

19. The method for producing an electrical insulation tape of claim 11,
wherein producing the electrical insulation tape comprising the impregnatable particle composite and first spacer particles applied to a surface of the electrical insulation tape is done by a dispersion that comprises the first spacer particles and a fluid being sprayed onto the surface.
